(19) United States
(12) Patent Application Publication
(10) Pub. No.: US 2013/0192757 A1
(43) Pub. Date: Aug. 1, 2013

(54) Web Processing Machine

(71) Applicant: Peter Philip Andrew Lymn, Waterlooville, Hampshire (GB)

(72) Inventor: Peter Philip Andrew Lymn, Waterlooville, Hampshire (GB)

(21) Appl. No.: 13/749,628

(22) Filed: Jan. 24, 2013

(30) Foreign Application Priority Data
Jan. 26, 2012 (GB) 1201353.8

(51) Int. Cl. B05C 3/132

(52) U.S. Cl. CPC B05C 3/132
USPC 156/345.2; 118/419

(57) ABSTRACT

A machine for processing of a web through a process tank containing process liquid and a tank containing wash water has in each tank an upper submerged guide and a pair of lower submerged guides, whereby the web passes on a sinusoidal path through the tank. Four drying guides are provided one above the over above the down-stream end of the processing tank. The guides have outlet slits 18 facing alternately up-stream and down-stream. A blower is provided for blowing air into the guides and out through the slits onto the web passing sinuously around the ducts. It acts both as a bearing medium holding the web off the surfaces of the ducts and as a drying medium.

### CROSS-REFERENCE TO RELATED APPLICATIONS

This application claims priority from U.K. Patent Application No. 1201353.8, filed Jan. 26, 2012, the disclosure of which is incorporated herein by reference.

### BACKGROUND OF THE INVENTION

The present invention relates to a machine for processing of a web through a process tank.

In my International Patent Application No PCT/GB2008/003311, published on 9Apr. 2009 under No. WO 2009/044124, there is described and claimed a machine for processing of a web through a process tank containing process liquid, the tank having:
guides for guiding the web along a sinuous path through the tank, the guides being
   in the form of parallel tubes,
   arranged as an upper set and a lower set of web guides defining the sinuous path, and
   provided with apertures for passage of fluid from within their tubes to act as fluid bearings supporting the web off the guides during passage through the tank and
means for supplying fluid to the guides for establishing the fluid bearings.

Typically, the process liquid can be an etchant, an electrolyte, an electro-less deposition solution or other chemical.

There can be a requirement for the web to be processed through two similar tanks with different liquids and without carrying of one liquid into the next tank, or indeed, for thorough removal for the process liquid after the web has passed through just one tank.

The object of the present invention is to provide an improved web processing machine.

### SUMMARY OF THE INVENTION

According to the invention there is provided a machine for processing of a web through a process tank containing process liquid, the machine comprising:
a process tank;
a plurality of guides for guiding the web to follow a rising sinuous path from a web exit of the tank, the guides being:
   in the form of parallel tubes,
   arranged one above the other and
   provided with oppositely directed apertures for air flow from within their tubes to act both:
      as a fluid bearing medium for the web as it passes sinuously around the guides and
      as a drying medium for drying the process liquid off the web and
means for supplying air to the guides for flow from the apertures.

The air can be supplied at ambient temperature or means can be provided for heating it above ambient for supply to the guides.

It is envisaged that the sinuous path defining guides could be arranged as an outer and an inner set defining the sinuous path with horizontal or slightly inclined steps between the guides, the guides being horizontally further and nearer to the tank. However in the preferred embodiment, the guides are provided directly one above the other defining the sinuous path with steeply inclined steps between the guides.

The apertures can be slits along the length of the tubes or lines of bores along the length of the tubes or a combination of both.

### BRIEF DESCRIPTION OF THE DRAWINGS

To help understanding of the invention, a specific embodiment thereof will now be described by way of example and with reference to the accompanying drawings, in which:

FIG. 1 is a side view of a web processing machine in accordance with the invention and

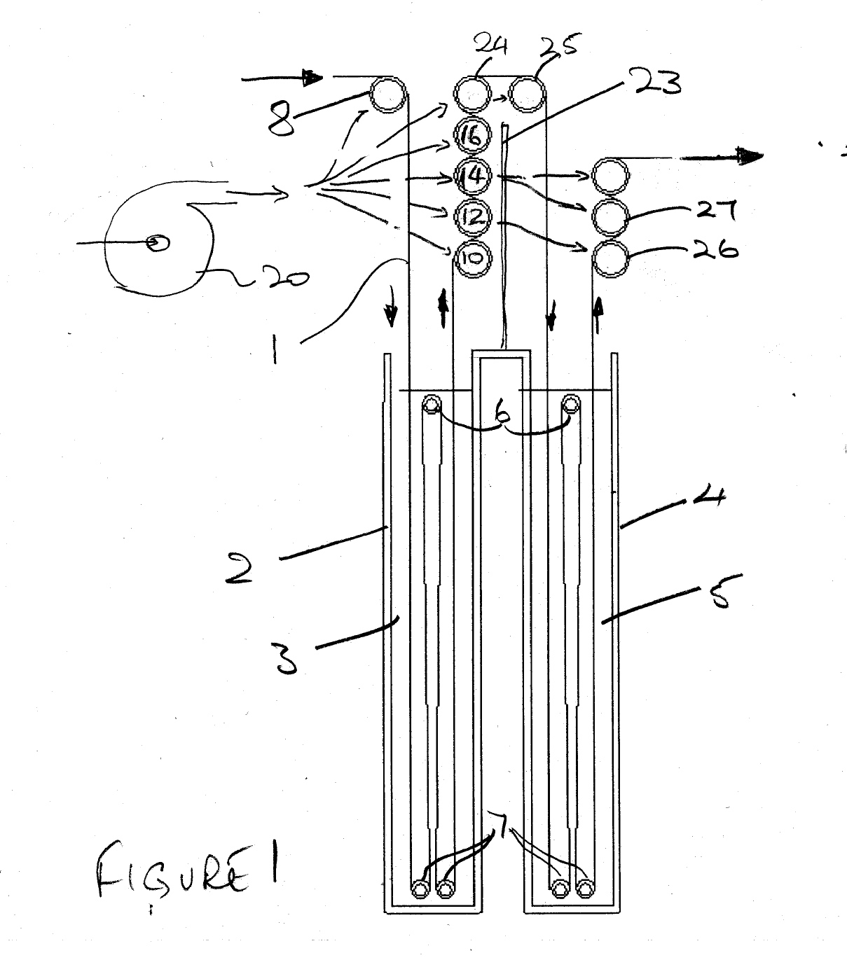

FIG. 2 is a scrap view on a larger scale of drying operation of the guides.

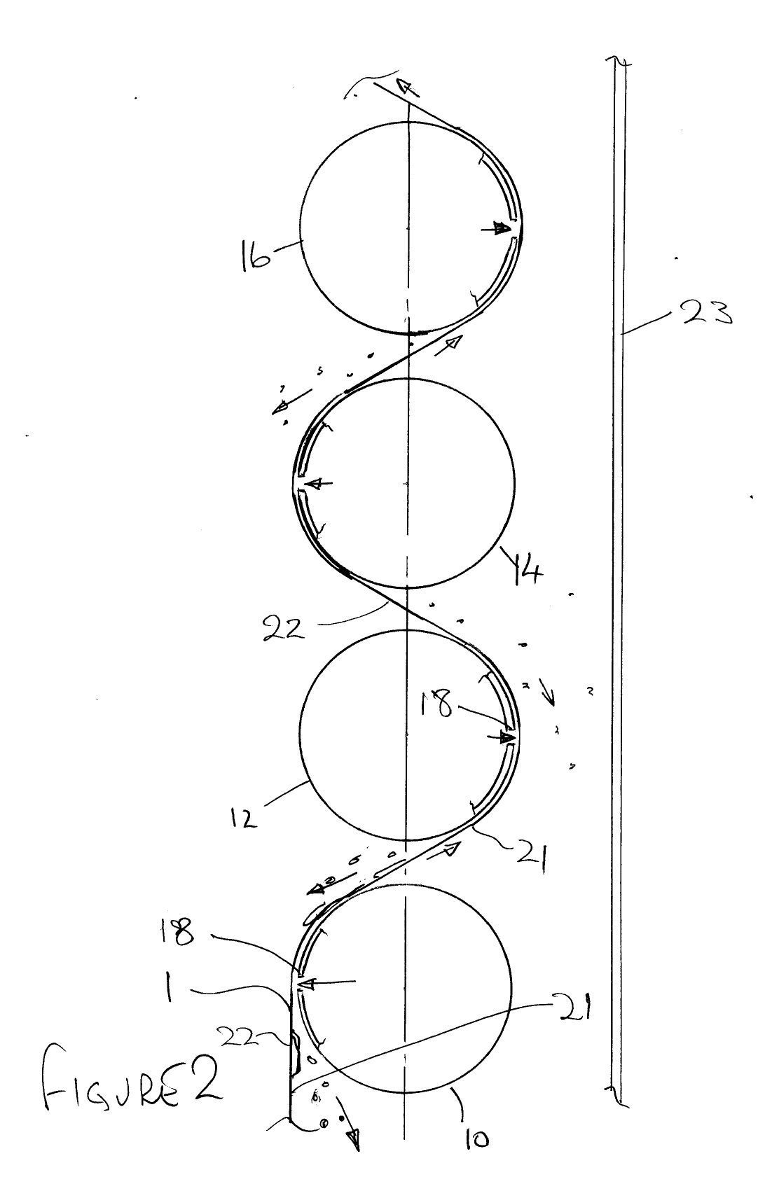

### DETAILED DESCRIPTION OF THE PREFERRED EMBODIMENT

Referring to the drawings, a web 1 is shown being passed through a tank 2 of processing chemical 3 and a tank 4 of wash water 5. Each tank has an upper submerged guide 6 and a pair of lower submerged guides 7, whereby the web passes on a sinusoidal path through the tank.

An in-feed guide 8 is provided above and upstream of the processing tank.

Four drying guides 10, 12, 14, 16 are provided one above the over above the down-stream end of the processing tank. The guides have outlet slits 18 facing alternately up-stream and down-stream. A blower 20 is provided for blowing air into the guides and out through the slits onto the web passing sinuously around the ducts. It acts both as a bearing medium holding the web off the surfaces of the ducts and as a drying medium. Whilst the slits could be cut to be not truly radial with respect to the tubular guides so as to face upstream for drying action, preferably they are radial and air flowing from them spreads up- and down-stream against the web as a bearing medium. The upstream portion, actually flow downwards, tends to entrain moisture on the web and blow it down off the web. Thus the air flow acts in the manner of air knives directing liquid entrained with the web back towards the tank 2.

The air from the first guide 10 acts on the face 21 of the web facing towards the wash tank 4. The liquid carried up the web to the guide is blown back down it as droplets or is separated from it as droplets which fall back to the tank. Similarly air from the second guide 12 blows liquid back down the face 22 of the web or as droplets, which possibly impinge on the web as it is passed into the tank. Any liquid passing the slit in the first guide may be blown off the web by the up-flow and is directed to a divider sheet 23 and thence back into the processing tank. At the next guide 14, the remaining liquid on the face 21, if any, is blown off towards the divider. Similarly liquid remaining on the face 22 is blow off by the air from guide 16.

Above the four guides, another pair 24, 25 of guides is provided for turning the web back towards the wash tank 4. The second of these rollers acts as an in-feed roller for the wash tank 4. Downstream and above this a single pair of drying guides 26, 27 only is provided, because the wash water is more easily removed, is cheaper and is not hazardous.

Where the guides are acting primarily as drying guides, i.e. guides 10, 12, 26, 27, they have air outlet slits 18. These may be augmented by second slits where much liquid is expected to have to be removed—fast web travel with the web being hydrophilic. Where air bearing action is expected to require augmentation, the slits can be augmented by aligned bores in the guides.

The invention is not intended to be restricted to the details of the above described embodiment. For instance, the number of drying guides may be more or less than four, in particular the number of drying guides may be two.

What is claimed is:

1. A machine for processing of a web through a process tank containing process liquid, the machine comprising:
a process tank;
a plurality of guides for guiding the web to follow a rising sinuous path from a web exit of the tank, the guides being:
in the form of parallel tubes,
arranged one above the other and
provided with oppositely directed apertures for air flow from within their tubes to act both:
as a fluid bearing medium for the web as it passes sinuously around the guides and
as a drying medium for drying the process liquid off the web and
means for supplying air to the guides for flow from the apertures.

2. A machine for processing of a web through a process tank as claimed in claim 1, wherein the machine has two guides for guiding the web to follow a rising sinuous path from a web exit of the tank.

3. A machine for processing of a web through a process tank as claimed in claim 1, wherein the machine has four guides for guiding the web to follow a rising sinuous path from a web exit of the tank.

4. A machine for processing of a web through a process tank as claimed in claim 1, wherein the machine further comprises means for supplying ambient temperature air to the guides.

5. A machine for processing of a web through a process tank as claimed in claim 1, wherein the machine further comprises means for heating air above ambient temperature for supply to the guides and means for supplying the heated air to the guides.

6. A machine for processing of a web through a process tank as claimed in claim 1, wherein the sinuous path defining guides are arranged as an outer and an inner set defining the sinuous path with horizontal or slightly inclined steps between the guides, the guides being horizontally further and nearer to the tank.

7. A machine for processing of a web through a process tank as claimed in claim 1, wherein the guides are provided directly one above the other defining the sinuous path with steeply inclined steps between the guides.

8. A machine for processing of a web through a process tank as claimed claim 1, wherein the apertures are slits along the length of the tubes.

9. A machine for processing of a web through a process tank as claimed in claim 1, wherein the apertures are bores along the length of the tubes.

10. A machine for processing of a web through a process tank as claimed in claim 1, wherein the apertures are a combination of slits and bores along the length of the tubes.
